(19) United States
(12) Patent Application Publication
(10) Pub. No.: US 2016/0254835 A1
(43) Pub. Date: Sep. 1, 2016

(54) INTEGRATED SCREEN AND PERIMETER PROTECTOR FOR AN ELECTRONIC DEVICE

(71) Applicant: M-Edge International Corporation, Hanover, MD (US)

(72) Inventors: Adam R. ASHLEY, Crownsville, MD (US); Christopher R. HELMAN, Linthicum, MD (US); Jonathan D. MCCUNE, Chester, MD (US); Joshua B. KING, Linthicum Heights, MD (US)

(21) Appl. No.: 15/056,840

(22) Filed: Feb. 29, 2016

Related U.S. Application Data
(60) Provisional application No. 62/121,977, filed on Feb. 27, 2015.

(51) Int. Cl. H04B 1/3888

(52) U.S. Cl. CPC H04B 1/3888

(57) ABSTRACT

A screen and perimeter protector is provided that includes one or more of a screen protection layer, an outer layer, and/or an internal liner, as a single piece. A device is inserted into the screen and perimeter protector by pushing the front side of the electronic device containing the display into the back side of the screen and perimeter protector. Thus, the screen protector layer does not need to be adhered to the electronic device and the back side of the electronic device is exposed to the atmosphere, while the front side and perimeter are protected from impacts and the environment.

### RELATED APPLICATIONS

This application claims priority to U.S. provisional application 62/121,977, filed on Feb. 27, 2015, the contents of which are hereby incorporated in their entirety.

### BACKGROUND

Many consumers of mobile electronic devices, such as a smartphone, smartwatch, or tablet, elect to protect the device with a case. A case may refer to a protective layer that extends around the majority of the back side of the device and along the majority of the perimeter (e.g., the sides) of the device. The case typically “grips” the mobile device by flexing around the perimeter of the device to extend over the bezel of the front face of the device. Some protective cases for portable devices have multiple components that are assembled by the end user. For example, a case may include a back piece that connects to a screen-protection component consisting of a transparent layer that protects the screen of the device while allowing the user to interface with it. Typically, these cases also include multiple impact-resistant components that are assembled by the user to encapsulate and protect the device from impact. Although these cases are protective, they are also bulky, making it difficult to access and interact with the ports, buttons, cameras, sensors, microphones, and others features of the device. In addition, installing and removing the device is a challenge due to the complexity of the parts and the way they are assembled.

Another form of protection for a mobile device is a screen protector. A screen protector may refer to a thin, flexible or rigid, transparent film that is coated on one side with an adhesive or glue. The screen protector may be placed on the front side of the device (i.e., the side containing the display), thereby making the screen less prone to scratches or other minor impacts. Because the screen protector can be flexible, it may be formed to match the contour of the display; however, it does not offer any protection to any other side of the electronic device (e.g., perimeter and back side). The screen protector may extend across the entire front face of the device; have openings for an input (e.g., camera, button, etc.) and/or an emissive part of the device (e.g., light, speaker(s), microphones, and/or sensors (e.g. light, proximity). A screen protector can also be difficult to install because dust and/or fibers that become trapped between the device screen and the screen protector form visible air bubbles. Over time, an improperly installed screen protector can experience the formation of additional air bubbles between the display of the electronic device and the screen protector.

Thus, a screen protector does not protect the sides or back of the portable device, while a case usually protects the back and sides of a device. Some cases may be combined with a screen protector or a screen protection component as two independent pieces.

### BRIEF SUMMARY

According to an embodiment of the disclosed subject matter, a screen and perimeter protector for an electronic device is provided that includes a screen protection layer. The screen protection layer is made of a transparent material that extends over at least a portion of a front side of the electronic device containing a display. The transparent material also extends over at least a portion of a perimeter of the device (e.g., the sides of the device). The transparent material is not adhered to any component of the electronic device. The transparent material extends over at least a portion of a back side of the electronic device such that the electronic device is secured in the screen and perimeter protector. In an implementation greater than 75% of the back side of the electronic device is exposed to atmosphere when the electronic device is disposed in the screen and perimeter protector. In some configurations, greater than 90%, 95%, 98%, or 99% of the back side of the electronic device is exposed to the atmosphere.

The portion of the back side of the electronic device that is extended over by the screen protection layer may be less than 5 mm, less than 4 mm, less than 3 mm, less than 2 mm, less than 1.0 mm, or less than 0.5 mm as measured from the perimeter edge to the edge of the screen protector layer. The screen protection layer may extend over one or more corners of the electronic device.

In some configurations, the screen protection layer may be rigid. The transparent material may be made of glass, polycarbonate, polyethylene, or a composite material. The transparent material may be greater than 95% transparent. The thickness of the screen protection layer may be less than 1.0 mm thick, less than 0.8 mm thick, less than 0.6 mm thick, less than 0.5 mm thick, or less than 0.4 mm thick. In the event that the screen of the electronic device is curved, the shape of the screen protection layer may match the contour of the curved screen.

The screen protection layer may have an opening for at least one or more sensors, emissive components, cable inputs, and input keys of the electronic device. In some instances, the openings in the screen protection layer may refer to perforations in the transparent material. Thus, the screen protection layer may extend over the entire perimeter of the electronic device except where the electronic device has a sensor, an emissive component, a cable input, or an input key of the electronic device.

In some configurations, the screen and perimeter protector may also include an outer layer that extends over the portion of the transparent material that extends over at least a portion of the perimeter of the electronic device. The outer layer and the screen protection layer may be bonded together. The outer layer may be made of a material such as liquid silicone rubber, polyurethane, polyethylene, silicone, gel, and rubber. The screen protector layer may be disposed between the outer layer and a portion of the perimeter of the electronic device.

In some configurations, the screen and perimeter protector may include an internal liner that is disposed between the portion of the screen protector layer that extends over at least a portion of the perimeter of the electronic device, and the electronic device when the electronic device is disposed in the screen and perimeter protector. The internal liner may be made of a material such as liquid silicone rubber, polyurethane, polyethylene, silicone, gel, and rubber. The internal liner may have a shape such as a spring or a ribbed shape. In some instances, the screen protection layer of the instant implementation may be combined with the outer layer and the internal liner as a single piece.

In an implementation, a system is provided that includes a screen and perimeter protector and a stand. The screen protection layer of the screen and perimeter protector may be made of a transparent material that extends over at least a portion of a front side of the electronic device containing a display. The transparent material may extend over at least a portion of a perimeter of the device (e.g., the sides of the device). In a preferred embodiment, the transparent material is not adhered to any component of the electronic device. The transparent material extends over at least a portion of a back side of the electronic device such that the electronic device is secured in the screen and perimeter protector. In an implementation, greater than 75% of the back side of the electronic device is exposed to atmosphere when the electronic device is disposed in the screen and perimeter protector. In some configurations, greater than 90%, 95%, 98%, or 99% of the back side of the electronic device is exposed to the atmosphere.

The stand may include a perimeter portion that extends over a portion of the screen protection layer that extends over a portion of the front side and the perimeter of the electronic device. The stand may include a first back portion that extends over a portion of the back side of the electronic device when the electronic device is disposed in the screen and perimeter protector. The stand may include a first hinge region that connects the first back portion to a second back portion. The stand may include a second hinge region that connects the second back portion to a third back portion. The second back portion, in a first position, may be planar with respect to the first back portion. The second back portion may be positioned in a second position that extends outward from the first back portion of the stand. In the second position, the weight of the electronic device may rest against or be supported by the stand. In the first position, the third back portion may be parallel to the display of the device or articulated away from the display of the device by 180 degrees. The third back portion may be parallel to a surface on which the electronic device is positioned when the second back portion is in the second position.

In an implementation, a screen and perimeter protector for an electronic device that includes a screen protection layer made of a transparent material, and an outer layer. The screen protection layer may extend over at least a portion of a front side of the electronic device containing a display. In a preferred embodiment, the transparent material is not adhered to any component of the electronic device. The outer layer may extend over at least a portion of a perimeter of the electronic device. The screen protection layer and the outer layer are bonded together. At least a portion of the outer layer may extend over a portion of a back side of the electronic device, such that the electronic device is secured in the screen and perimeter protector by the outer layer. In an implementation, greater than 75% of the back side of the electronic device is exposed to atmosphere when the electronic device is disposed in the screen and perimeter protector according to this implementation. In some configurations, greater than 90%, 95%, 98%, or 99% of the back side of the electronic device is exposed to the atmosphere.

The portion of the back side of the electronic device that is extended over by the outer layer may be less than 5 mm, less than 4 mm, less than 3 mm, less than 2 mm, less than 1.0 mm, or less than 0.5 mm as measured from the perimeter edge to the edge of the screen protector layer. The outer layer may extend over one or more corners of the electronic device.

In some configurations, the screen protection layer may be rigid. The transparent material may be glass, polycarbonate, polyethylene, or a composite material. The transparent material may be greater than 95% transparent. The thickness of the screen protection layer may be less than 1.0 mm thick, less than 0.8 mm thick, less than 0.6 mm thick, less than 0.5 mm thick, or less than 0.4 mm thick. In the event that the screen of the electronic device is curved, the shape of the screen protection layer may match the contour of the curved screen.

The screen protection layer may have an opening for at least one or more sensors, emissive components, cable inputs, and input keys of the electronic device. In some instances, the openings in the screen protection layer may refer to perforations in the transparent material. Thus, the screen protection layer may extend over the entire perimeter of the electronic device except where the electronic device has a sensor, an emissive component, a cable input, or an input key of the electronic device.

Similarly, the outer layer may have a shape that matches or follows the contour of the perimeter of an electronic device that has a curved screen. The outer layer may have one or more openings that align with one or more sensors, emissive components, cable inputs, and input keys of the electronic device. The outer layer may have a thickness that is less than 8 mm thick, less than 7 mm thick, less than 6 mm thick, less than 5 mm thick, or less than 3 mm thick. The outer layer may be a material such as liquid silicone rubber, polyurethane, polyethylene, silicone, gel, and rubber. The outer layer may be offset from the perimeter of the device by a distance of less than 0.3 mm or less than 0.1 mm.

In some configurations, the screen and perimeter protector may include an internal liner that is disposed between the outer layer and the electronic device when the electronic device is disposed in the screen and perimeter protector. The internal liner may be a material such as liquid silicone rubber, polyurethane, polyethylene, silicone, gel, and rubber. The internal liner may have a shape such as a spring or a ribbed shape. In some instances, the screen protection layer of the instant implementation may be combined with the outer layer and the internal liner as a single piece. The internal liner may be offset from the perimeter of the device by a distance of less than 0.3 mm or less than 0.1 mm.

In an implementation, a system is provided that includes a screen and perimeter protector and a stand. The screen protection layer of the screen and perimeter protector may be made of a transparent material that extends over at least a portion of a front side of the electronic device containing a display. The transparent material is not adhered to any component of the electronic device. An outer layer and the screen protection layer are bonded together. The outer layer extends over at least a portion of the perimeter of the electronic device and at least a portion of the back side of the electronic device such that the electronic device is secured in the screen and perimeter protector. Greater than 75% of the back side of the electronic device is exposed to atmosphere when the electronic device is disposed in the screen and perimeter protector. In some configurations, greater than 90%, 95%, 98%, or 99% of the back side of the electronic device is exposed to the atmosphere.

The stand may include a perimeter portion that extends over a portion of the outer layer that extends over a portion of the front side and the perimeter of the electronic device. The stand may include a first back portion that extends over a portion of the back side of the electronic device when the electronic device is disposed in the screen and perimeter protector. The stand may include a first hinge region that connects the first back portion to a second back portion. The stand further includes a second hinge region that connects the second back portion to a third back portion. The second back portion, in a first position, may be planar with respect to the first back portion. The second back portion may be positioned in a second position that extends outward from the first back portion of the stand. In the second position, the weight of the electronic device may rest against or be supported by the stand. In the first position, the third back portion may be parallel to the display of the device or articulated away from the display of the device by 180 degrees. The third back portion may be parallel to a surface on which the electronic device is positioned when the second back portion is in the second position. The third back portion may be parallel to a surface on which the electronic device is positioned when the second back portion is in the second position.

Additional features, advantages, and embodiments of the disclosed subject matter may be set forth or apparent from consideration of the following detailed description, drawings, and claims. Moreover, it is to be understood that both the foregoing summary and the following detailed description provide examples of various implementations and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced. For ease of explanation, the same reference numerals are used throughout the specification to refer to the same components.

FIG. 1 is an example of an implementation that includes an electronic device 1 and a screen and perimeter protector 15 from a front perspective.

FIG. 2 is an example of an implementation that includes an electronic device 1 and a screen and perimeter protector 15 from a back perspective.

FIG. 3 is an example of an implementation that shows a cross-section of a screen protector layer 16 from a back perspective.

FIG. 4 is an example of an implementation that shows a cross-section of a screen protector layer 16 bonded with an outer layer 20.

FIG. 5 is an example of an implementation that shows a cross-section of a screen and perimeter protector 15 from a back perspective with an internal liner 22.

FIG. 6 is an example of an implementation that includes a screen and perimeter protector 15 from a back perspective with an outer layer 20 and an internal liner 22.

FIG. 7 is an example of an implementation that includes a screen and perimeter protector 15, an electronic device 1, and a stand 23 from a front side perspective.

FIG. 8 illustrates an example implementation that includes a screen and perimeter protector 15, an electronic device 1, and a stand 23 from a back perspective.

FIG. 9 shows an example implementation of a stand 23 attached to a screen and perimeter protector 15 from a front perspective.

FIG. 10 shows an example of an implementation that includes a stand 23 attached to a screen and perimeter protector 15 from a rear perspective.

FIG. 11 shows an example of an implementation that includes a screen and perimeter protector 15 with a third back portion 31 folded over the front side of a screen and perimeter protector 15.

FIG. 12 shows an example of an implementation that includes a back side of a stand 23 where a second back portion 29 is in a first position, and a third back portion 31 is folded over a front side of the screen and perimeter protector 15.

FIG. 13 illustrates an example implementation that includes a front perspective of a stand 23 in which a third back portion 31 is in the same plane as a first back portion 27 and a second back portion 29.

FIG. 14 is an example implementation that shows a back perspective of a stand 23 when a third back portion 31 is flush with a first back portion 27 and a second back portion 29.

FIG. 15 shows an example implementation that includes electronic device 1 disposed in a screen and perimeter protector 15 from a back perspective.

FIG. 16 shows an example implementation that includes an electronic device 1 disposed in a screen and perimeter protector 15 from a front perspective.

FIG. 17 shows an example implementation that includes a cross-section view of screen and perimeter protector 15 from a back perspective, including an outer layer 20, a screen protector layer 16, and an internal liner 22.

FIG. 18 shows an example implementation that includes a top side of a screen and perimeter protector 15.

FIG. 19 shows an example of an implementation that includes a bottom side of a screen and perimeter protector 15.

FIG. 20 shows an example implementation of a screen and perimeter protector 15 that includes a screen protector layer 16, an outer layer 20, and an inner liner 22 from a back side.

FIG. 21 shows an example implementation of a screen and perimeter protector 15 that includes a screen protector layer 16, an outer layer 20, and an inner liner 22 from a front side.

FIG. 22 shows an example implementation of a screen and perimeter protector 15 that includes a screen protector layer 16, an outer layer 20, and an inner liner 22 from a left side.

FIG. 23 shows an example implementation of a screen and perimeter protector 15 that includes a screen protector layer 16, an outer layer 20, and an inner liner 22 from a right side.

FIG. 24 shows an example implementation of a screen and perimeter protector 15 that includes a screen protector layer 16, an outer layer 20, and an inner liner 22 from a back perspective.

FIG. 25 shows an example implementation of a screen and perimeter protector 15 that includes a screen protector layer 16, an outer layer 20, and an inner liner 22 from a front perspective.

FIG. 26 shows an example implementation of a screen and perimeter protector 15 for a smartwatch that includes a screen protector layer 16, an outer layer 20, and an inner liner 22 from a front side.

FIG. 27 shows an example implementation of a screen and perimeter protector 15 for a smartwatch that includes a screen protector layer 16, an outer layer 20, and an inner liner 22 from a back side.

FIG. 28 shows an example implementation of a screen and perimeter protector 15 for a smartwatch that includes a screen protector layer 16, an outer layer 20, and an inner liner 22 from a top side.

FIG. 29 shows an example implementation of a screen and perimeter protector 15 for a smartwatch that includes a screen protector layer 16, an outer layer 20, and an inner liner 22 from a bottom side.

FIG. 30 shows an example implementation of a screen and perimeter protector 15 for a smartwatch that includes a screen protector layer 16, an outer layer 20, and an inner liner 22 from a left side.

FIG. 31 shows an example implementation of a screen and perimeter protector 15 for a smartwatch that includes a screen protector layer 16, an outer layer 20, and an inner liner 22 from a right side.

FIG. 32 shows an example implementation of a screen and perimeter protector 15 for a smartwatch that includes a screen protector layer 16, an outer layer 20, and an inner liner 22 from a front perspective.

FIG. 33 shows an example implementation of a screen and perimeter protector 15 for a smartwatch that includes a screen protector layer 16, an outer layer 20, and an inner liner 22 from a back perspective.

FIG. 34 shows an example implementation of a cross section of the screen and perimeter protector 15 for a smartwatch that includes a screen protector layer 16, an outer layer 20, and an inner liner 22.

FIG. 35 is an example implementation that shows an electronic device 1 and a screen and perimeter protector 15 for a smartwatch that includes a screen protector layer 16, an outer layer 20, and an inner liner 22.

FIG. 36 is an example implementation that shows an electronic device 1 disposed in a screen and perimeter protector 15 for a smartwatch that includes a screen protector layer 16, an outer layer 20, and an inner liner 22.

### DETAILED DESCRIPTION

A screen and perimeter protector is provided that includes one or more of a screen protection layer, an outer layer, and/or an internal liner. The screen and perimeter protector is provided as a single unit to the end user such that it is easy to insert an electronic device into the protector. The advantages of the screen and perimeter protector are that it is easy to install and remove, that it does not require any glue or adhesive, that it is thin, and that it offers protection to the display and chassis or housing of the electronic device.

A user may insert an electronic device into the screen and perimeter protector by pushing the front side of the electronic device containing the display into the back side of the screen and perimeter protector. The screen and perimeter protector may be designed to have an opening on the back side that is slightly smaller than the dimensions of the electronic device. A user can install a device into the screen and perimeter protector by first inserting the display side into the back side of the screen and perimeter protector. The material forming the screen and perimeter protector can flex slightly until the electronic device is fully inserted and the sides of the screen and perimeter protector engage with the perimeter of the electronic device. In this regard, the back side of the screen and perimeter protector is largely exposed to the atmosphere, while the perimeter securely holds or grips the electronic device, and the front side of the electronic device is protected from impact, dust, and other possible damaging effects.

As stated above, the screen and perimeter protector according to the present embodiments may include a slim, shock-absorbing outer layer, which provides impact protection to the perimeter of the device and a fully integrated screen protection layer, which protects the screen of the device from impact and scratches. The screen and perimeter protector protects the screen from scratching or other damage as well as the perimeter (e.g., the left side, right side, bottom side, and top side) of the device. In the event that an electronic device disposed in the screen and perimeter protector is dropped, the protective outer layer on the perimeter may receive the impact. In some embodiments, an internal liner with a shock-absorbing capability is provided that isolates the electronic device from impact. The screen-protection layer can be a rigid or flexible, and protects the screen from damage while providing full functionality of the display interface (e.g., haptic feedback, capacitive touch interface, operation of the device's sensors and radios, etc.). The screen-protection layer may be permanently bonded during the manufacturing process to the outer layer, resulting in a one-piece construction that is slim and easy for the user to install and remove the device. Various methods of bonding materials can be applied to the manufacture of the screen and perimeter protector as provided herein. Examples of bonding include sonic welding, heat-sensitive adhesive, bonding during the molding process such as injection molding, and use of adhesive or glue. In instances where adhesive or glue is utilized, it can be applied to the portions of the layers that contact with one another.

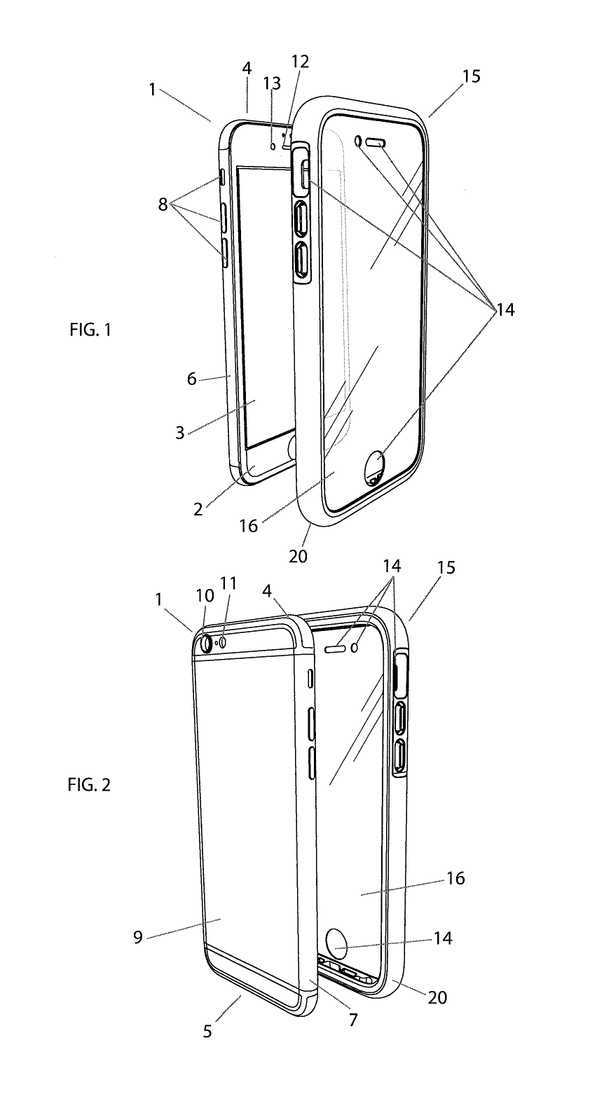

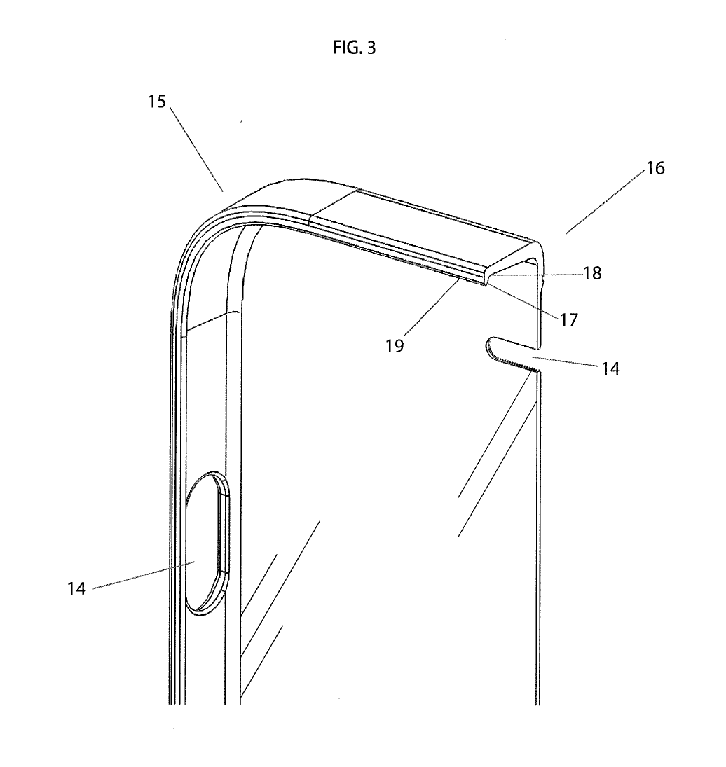

The screen and perimeter protection layer can accommodate a wide variety of electronic device geometries and sizes. An electronic device typically has a number of sides. As shown in FIGS. 1 and 2, the electronic device 1 may have a front side 2 that has an electronic display 3, a back side 9, a top side 4, bottom side 5, left side 6, and right side 7, any and/or all of which may include one or more inputs (e.g., headphone jack, data cable input, charging cable, a computer readable memory card input (e.g., microSD card), a subscriber identification module (SIM) card input), etc. Typically one or both of the front side 2 and back side 9 of the electronic device 1 have a camera 10 and/or a light emission component (e.g., LED light) 11. Any of the sides may include emissive components such as a speaker, a radio antenna, light, etc. Any of the sides may include an input key (e.g., a volume key, a power key, a “home” button, etc.) 8. An input key 8 may refer to a button. Any of the sides may include a sensor such as a microphone 13 or a camera 10.

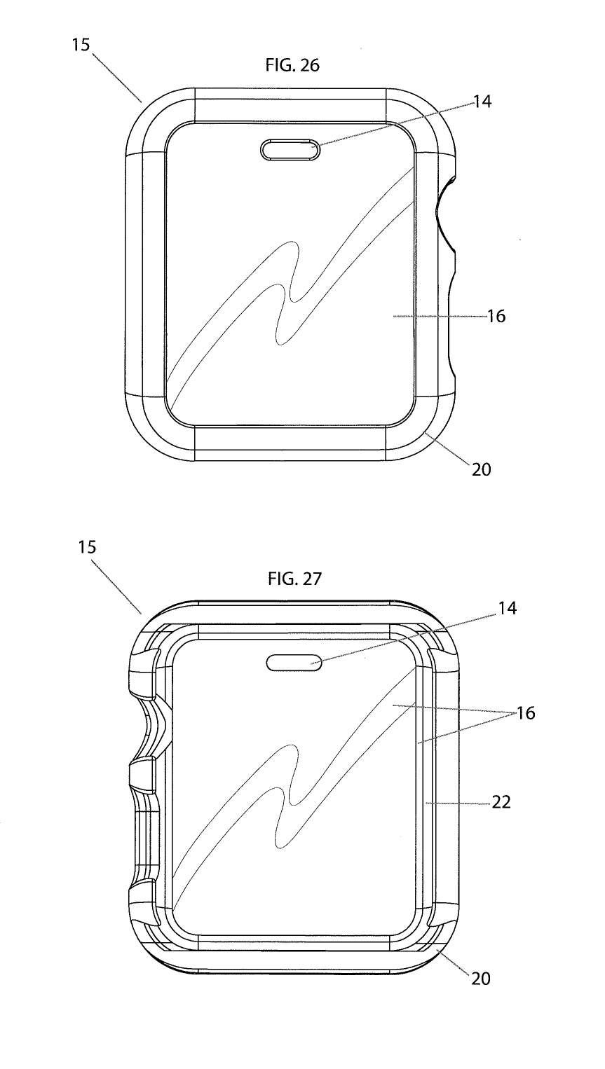

An electronic device may refer to, for example, a smartwatch, a smartphone, a tablet, a Global Positioning System device (GPS), a digital media device (e.g., digital music player), and/or a pager. As illustrated in FIGS. 26-36, the electronic device may have a curved screen and/or chassis. For example, the display portion of the electronic device may be concave (e.g., a smartphone) or convex (e.g., a smartwatch). The chassis may have a contour that matches the curvature of the display. The implementations disclosed herein contemplate that the screen and perimeter protector can be adapted to accommodate an electronic device with a curved display. Moreover, the size of the screen and perimeter protector may be adapted for a variety of electronic devices without limitation.

The screen and perimeter protector 15 disclosed herein may include openings 14 to accommodate one or more of the emissive components, sensors, inputs, and keys. The openings 14 in the screen and perimeter protector 15 may allow a user to directly contact or touch the one or more of the emissive components, sensors, inputs, and keys 8 when the screen and perimeter protector 15 is installed on the electronic device. In some configurations, the openings in the screen and perimeter protector may refer to the material of the screen and perimeter protector being perforated. For example, FIG. 1 illustrates a speaker 12 on the front side of the electronic device. The opening for the speaker in this instance is perforated, which prevents direct contact of the speaker by a user, but allows energy to be transmitted from or by the electronic device 1 (e.g., radio waves, audio, etc.).

Implementations of the presently disclosed screen and perimeter protector can include one or more components: a screen protector layer, an outer layer, and/or an internal liner. With regard to the screen protector layer, it is manufactured out of a transparent layer such as glass, polycarbonate, polyethylene, and/or a suitable composite material. The screen protector layer may have a thickness that is less than 1.0 mm, less than 0.8 mm, less than 0.6 mm, less than 0.5 mm, and/or less than 0.4 mm. Generally, a thickness between 0.3 and 0.7 mm is advantageous because such thicknesses keep the overall weight low, while maintaining suitable impact and/or scratch protection. Moreover, a thickness between 0.3 and 1.0 mm enables the features of the device to function unhindered. For example, a capacitive touch screen can function with a layer that has a thickness of 0.6 mm or less. The thickness of the screen protector layer may be uniform or it may vary. For example, the thickness of the screen protector layer may be tapered or reduced in a region, such as one surrounding a feature of the electronic device (e.g., an input key). As another example, the thickness over an input key may be greater than the surrounding thickness of the screen protector layer. Thus, the screen protector layer is thin so that a user can interface with the device through the aforementioned interface technologies.

The screen protector layer may be rigid or flexible. As an example, materials suitable for screen protector layer may have a Young's modulus greater than 0.1 GPa. More specifically, materials that have a high enough Young's modulus so that they can maintain a general shape while unsupported may provide greater strength to the protector of the present application. That is, the screen and perimeter protector will fit tightly against the electronic device (e.g., an offset of less than 0.3 mm, less than 0.1 mm, and/or directly contact the device). For example, glass, which is generally considered rigid, has a Young's modulus between 50-90 GPa. In contrast, a screen protector is typically a thin film that offers no structural rigidity. The screen protector layer as disclosed herein may maintain this shape without the device present. The screen protector is made from a material that is transparent. In some configurations, the transparent material is greater than or equal to 95% transparent such that a user can clearly see the display of the device through the screen protector layer. The shape of the screen protector layer may match the contour of the display and/or chassis. For example, the screen protector layer may be rigid, injection-molded plastic made from clear polycarbonate. The screen protector layer may be offset from the display of the electronic device by 0.3 mm or less, or 0.1 mm or less. For example, the screen protector layer may contact the display of the electronic device. However, unlike the screen protector discussed earlier, in this configuration the screen protector layer is not adhered to the display of the electronic device.

The screen protector layer may have one or more openings for features of the electronic device as described above (e.g., a sensor, an emissive component, a cable input, an input key, etc.). An opening may refer to a place in the material in which there is no material present, or where the material is perforated. The openings may be aligned with the size of the input, key, sensor, etc. of the electronic device. That is, the opening may not be substantially larger than is required for the input, sensor, etc. to be actuated or function.

In some configurations, an outer layer is provided. An outer layer may be comprised of a shock absorbing material such as liquid silicone rubber, polyurethane, polyethylene, silicone, gel, and rubber. The outer layer may have a thickness of less than 8 mm thick, less than 7 mm thick, less than 6 mm thick, less than 5 mm thick, and/or less than 3 mm thick. In general, the thicker the outer layer, the more impact resistance that it can offer. Furthermore, it may be desirable to have a thinner outer layer so that the screen and perimeter protector do not add much weight or size to an electronic device. The thickness of the outer layer may be uniform or it may vary. For example, the thickness of the outer layer may be tapered or reduced in a region, such as one surrounding a feature of the electronic device (e.g., an input key). As another example, the thickness over an input key may be greater than the surrounding thickness of the outer layer. Thus, the outer layer may be manufactured from an impact-resistant material and protect the perimeter of the electronic device from impacts such as if the electronic device is dropped on its edge. Additionally, the outer layer may be made from a material that is anti-slip or, as described below, that may provide grip, preventing the screen and perimeter protector from slipping out of a user's hand or sliding off of a smooth surface. For example, the outer layer can be formed of a thermoplastic elastomer (TPE), such as 65 Shore A, or thermoplastic urethane (TPU) material. Finally, the outer layer can be formed with a geometry (e.g., shape and/or size) and materials that act as a gasket around the perimeter of the device, sealing the electronic device from exposure to dirt, dust, and/or moisture.

As with the screen protector layer, the outer layer may have openings that align with locations on the electronic device that include input keys, emissive components, cable inputs, one or more sensors, etc. The openings may be aligned with the size of the input, key, sensor, etc. of the electronic device. That is, the opening may not be substantially larger than is required for the input, sensor, etc. to be actuated or function. In some configurations, the outer layer may extend over an input key. In such instances, the outer layer may be form a ridge so that the input key can be found by touch alone. For example, the outer layer may have ridges that align with the location of the volume up and volume down keys of the electronic device.

The outer layer may match the contour of the chassis and/or screen of the electronic device. For example, a smartwatch may have a convex-shaped display. The outer layer may match the contour of the display and the chassis that holds the display of the smartwatch. The outer layer may be offset from the electronic device by 0.3 mm or less, or 0.1 mm or less. In some configurations it may contact the electronic device.

In some configurations, an internal liner is provided. The internal liner may be manufactured from a material such as liquid silicone rubber, polyurethane, polyethylene, silicone, gel, and rubber. The internal liner may be formed from thermoplastic elastomer (TPE), such as 65 Shore A, or thermoplastic urethane (TPU) material. The internal liner may be formed into the shape of a spring or a ribbed shape to act as a suspension for the electronic device and isolate it from impacts. The internal liner may be disposed between the electronic device and one of the screen protector layer and/or the outer layer. It may be offset from the electronic device by less than 0.3 mm or less, or 0.1 mm or less. In some configurations it may contact the electronic device.

In some configurations, the screen protector layer is bonded (i.e., permanently attached) to one or more of the outer layer and/or the internal liner during the manufacturing process. In operation, the electronic device may be pressed into the one-piece screen and perimeter protector by inserting the device, screen-first, into the rear of the screen and perimeter protector until the outer layer, and/or internal liner, flexes to form a seal enclosing the perimeter of the device.

Various configurations of the above screen protector layer, outer layer, and/or the internal liner are provided below. FIG. 3 illustrates a cross section of the screen protector layer from a back perspective. In an implementation, the screen and perimeter protector 15 may have a screen protector layer 16 as shown in FIG. 3. The screen protector layer 16 may be manufactured from a transparent material as described above. The screen protector layer can extend over a front side of the electronic device (e.g., to encompass the display of an electronic device disposed in the screen and perimeter protector). As described above, the screen protector layer 16 may have one or more openings 8 to accommodate the various features of the electronic device and/or to provide a user with the ability to contact directly the electronic device. The screen protector layer may extend over the perimeter (e.g., a top side 4, bottom side 5, left side 6, and right side 7) of the device 1 and, in some instances, have openings 14 that allow a user to contact directly the electronic device 1. A part of the screen protector layer 16 may extend over the perimeter (e.g., sides) and a portion of the back of the device. It may form a lip 17 that can grip the device.

In some configurations, the portion of the screen protector layer that extends over the perimeter of the electronic device may encompass only the corners of the electronic device. That is, when an electronic device is disposed in the screen protector layer with such a configuration, only the corner portions of the perimeter are protected (e.g., not exposed to atmosphere). A corner may refer to a region of the electronic device at which two sides (e.g., a top side and a left side) meet. The corner may form a 90 degree angle. A corner may also be rounded. While most electronic devices have four sides that form a perimeter (e.g., rectangular), some devices may have more than four sides. In such devices, the corner may be formed at an angle that is greater than 90 degrees (e.g., a hexagon). The screen and perimeter protector may have a geometry to accommodate devices with greater than four sides as well.

The length of corner protected by the screen protector layer may vary, such as from 2% of the overall width of the device to 15% of the overall width of the device, and/or 2 mm to 10 mm, 2 mm to 20 mm, 5 mm to 20 mm as measured from each side from each protected corner. In some configurations, the portion of the screen protector layer that extends over the perimeter of the electronic device may not include the corners of the electronic device. That is, the corners may be unprotected while the other portions of the perimeter (e.g., sides of the electronic device) may be protected.

The screen and perimeter protector 15 may grip or be securely attached to an electronic device by a portion of the screen protection layer that extends over a portion of the back side of the electronic device 17. The opening on the back side of the screen and perimeter protector 15 can be designed to be slightly smaller than the dimensions of the electronic device 1 so that when a user inserts the electronic device into the screen and perimeter protector 15, the material flexes around the device. The portion of the screen protector layer 16 that extends over the back side of the device is relatively small. For example, the material may extend around the back side of the device, as measured from an edge of the back side of the device 18 to the edge of where the material ends on the back side of the device 1, at a length of less than 5 mm, than 4 mm, less than 3 mm, less than 2 mm, less than 1.0 mm, and less than 0.5 mm. The edge of the back side of the device 18 may refer to the site where the edge of the perimeter of the electronic device would be disposed in the screen and perimeter protector. Thus, at least 75% of the back side of the electronic device is exposed to the atmosphere when the electronic device is disposed in the screen and perimeter protector. In some configurations, at least 90%, at least 95%, at least 98%, or at least 99% of the back side of the electronic device is exposed to atmosphere (e.g., a user can directly interface with over 98% of the electronic device), as illustrated in FIG. 3.

Because the screen and perimeter protector extends to at least a portion of the back side of the device, the screen protector layer does not require an adhesive to grab and/or securely hold the electronic device. The screen and perimeter protector can fit relatively snug against the electronic device, based on the offset of the screen protector layer and geometry (e.g., shape and/or size) of the screen and perimeter protector in relation to a particular electronic device. Thus, there is no need for an adhesive. The device is held securely (e.g., does not move in the screen and perimeter protector, or fall out of the screen and perimeter protector). Similarly, it is easier to install or uninstall and electronic device in the screen and perimeter protector because it snaps around the device. The geometry of the screen and perimeter protector also maintains a thin shape to the electronic device. A thin shape is desirable by end users.

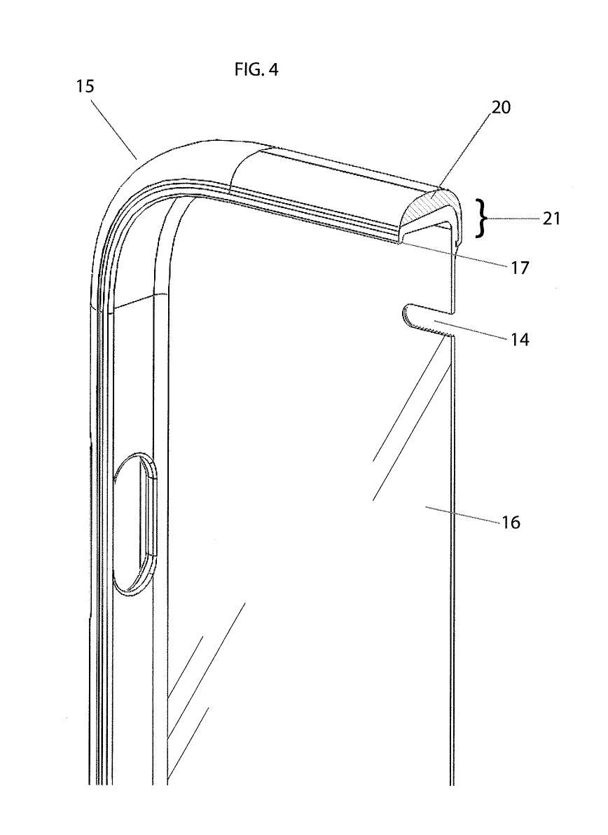

In some configurations, the screen and perimeter protector may further include an outer layer as described above. FIG. 4 shows a cross section of the screen protector layer 16 bonded with an outer layer 20. The screen protector layer 16 can extend around the perimeter of an electronic device and is disposed between the outer layer 20 and the electronic device when the electronic device is disposed in the screen and perimeter protector 15. The outer layer 20 may provide additional impact resistance to the sides of the electronic device. In this configuration, the screen protector layer contacts or is closest to the electronic device. Outer layer 20 may have a portion 21 that extends over a portion of the screen protector layer 16 on the front side of the screen and perimeter protector 15.

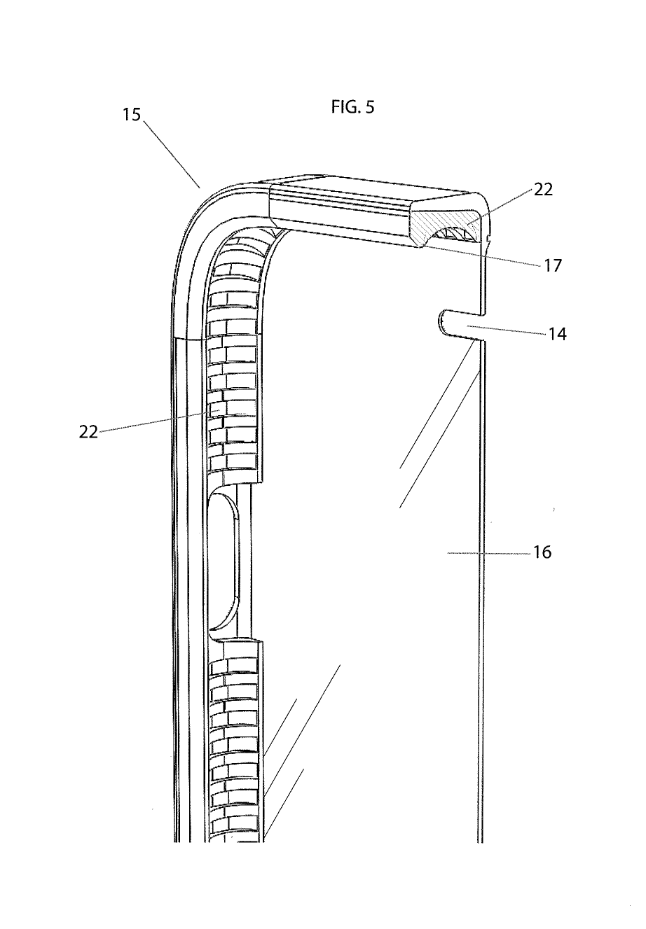

In some configurations, the screen and perimeter protector 15 may further include an internal liner 22, as described above and illustrated in FIG. 5, which is disposed between the portion of the screen protector layer 16 that extends over the sides and the electronic device when the electronic device is disposed in the screen and perimeter protector 15. In FIG. 5, the internal liner is ribbed or has a spring shape. The dimensions of each rib and the number of ribs in the internal liner may vary depending on the device size. The gaps between each rip may allow the ribs to move when the device receives an impact. The ribs may be spaced 0.5-5.0 mm apart, have a depth of 0.5 to 5.0 mm, and/or have a width of 0.5 to 5.0 mm. As an example, rib spacing for a watch may be 0.75 mm, 1.5 mm for a smartphone, and 2.5 mm for a tablet. The rib width may be 0.5 mm for a watch, 1.0 mm for a phone, and 2.0 mm for a tablet. The rib depth may be 0.5 mm for a watch, 0.75 mm for a phone, and 1.5 mm for a tablet. As stated above, these dimensions are merely examples. The precise dimensions for the ribs may be altered based on the device.

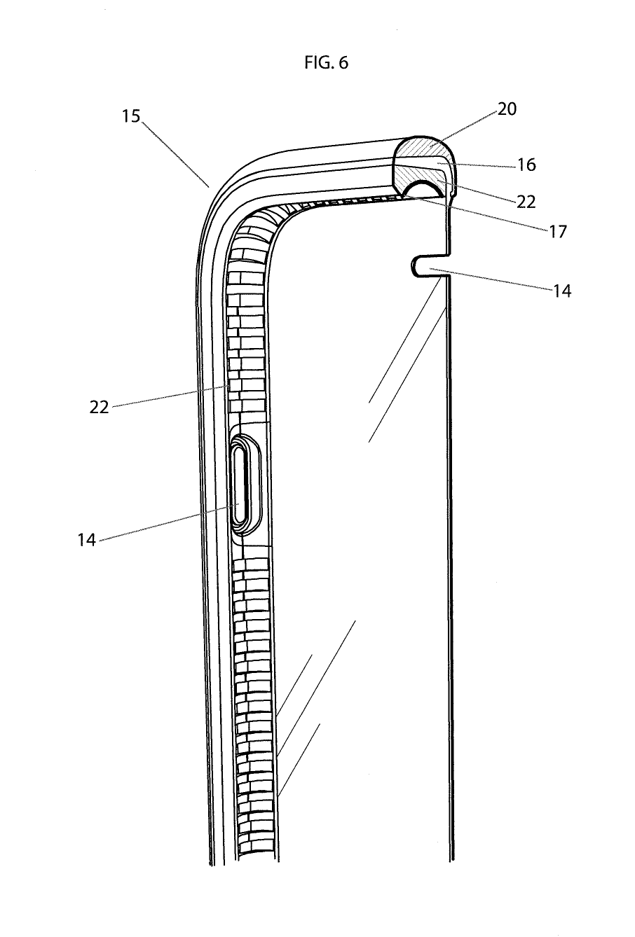

The screen protector layer and the internal liner may be bonded together. FIG. 6 shows a screen and perimeter protector 15 from a back perspective with an outer layer 20 and an internal liner 22 according to the present implementation. The configuration illustrated in FIG. 6 can offer even more impact resistance to the electronic device 1. As shown in FIG. 6, the screen protector layer 16 is disposed between the outer layer 20 and the internal liner 22. In this configuration, the internal liner 22 contacts or is closest to the electronic device 1, while the outer layer 20 is furthest from the electronic device 1.

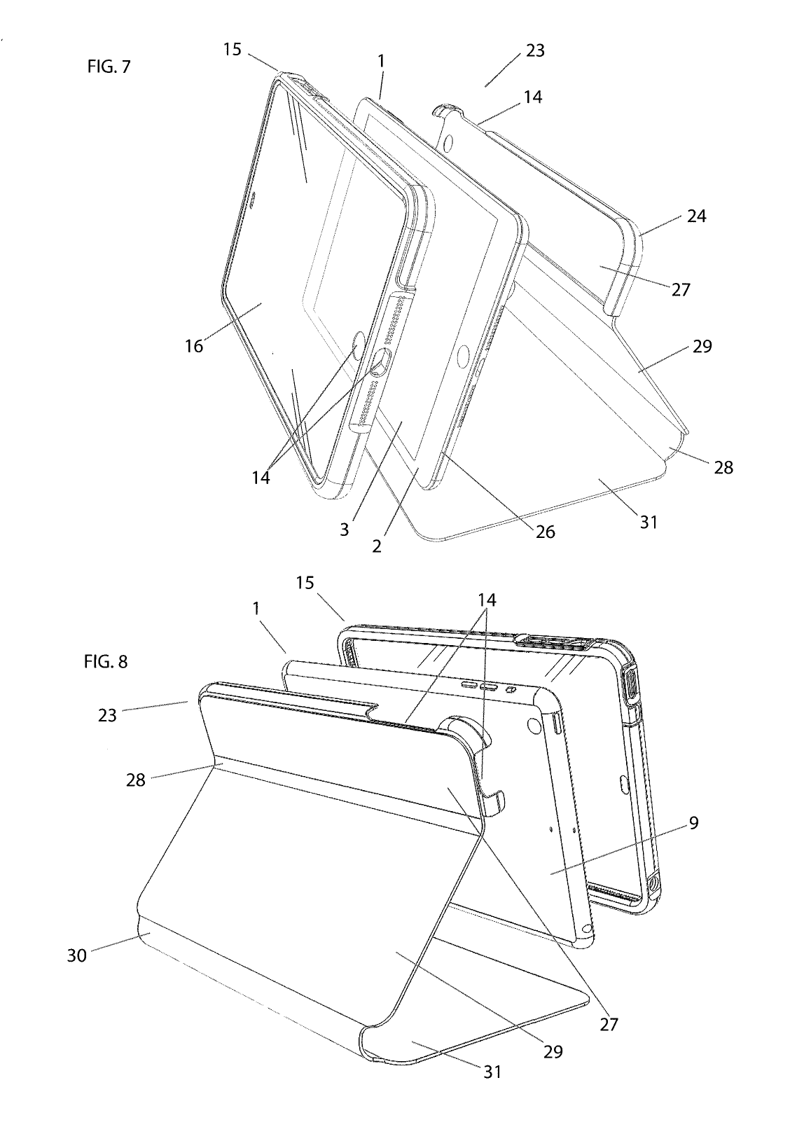

In an implementation, a system is provided that includes the screen and perimeter protector with a screen protection layer that extends over at least a portion of the perimeter of the electronic device, and a stand. An example of a stand in this configuration is illustrated in FIGS. 7-20.

FIG. 7 shows a screen and perimeter protector 15, an electronic device 1, and a stand 23 from a front side perspective. The stand may be removably attached to the screen and perimeter protector. FIG. 8 illustrates the screen and perimeter protector 15, the electronic device 1, and the stand 23 from a back perspective. The stand 23 may include a perimeter portion 24 that extends over a portion of the screen protection layer that extends over the front side 2 and perimeter of the electronic device 1. For example, the stand 23 may grip or be securely attached to the electronic device 1 and/or the screen and perimeter protector 15 by the portion of the stand 23 that extends over a portion of the front side 2 of the electronic device 1. The stand 23 may be designed to engage with the exterior of the screen and perimeter protector, so that when a user presses the stand 23 over the screen and perimeter protector 15, the stand material flexes and snaps over a portion of the perimeter 26 of the electronic device 1. The portion of the stand that extends over the front side 2 of the electronic device 1 and/or screen and perimeter protector does not obstruct the display 3 and/or other features of the electronic device 1. The stand 23 may have openings 14, similar to those previously described with respect to the screen protector layer 16 and outer layer 20. In some configurations, the portion of the stand 23 that extends to the front side 2 of the device 1 extends over just the bezel of the front side 2 of the device 1. The method by which the screen and perimeter protector grips or secures the electronic device may be applied to the stand as well.

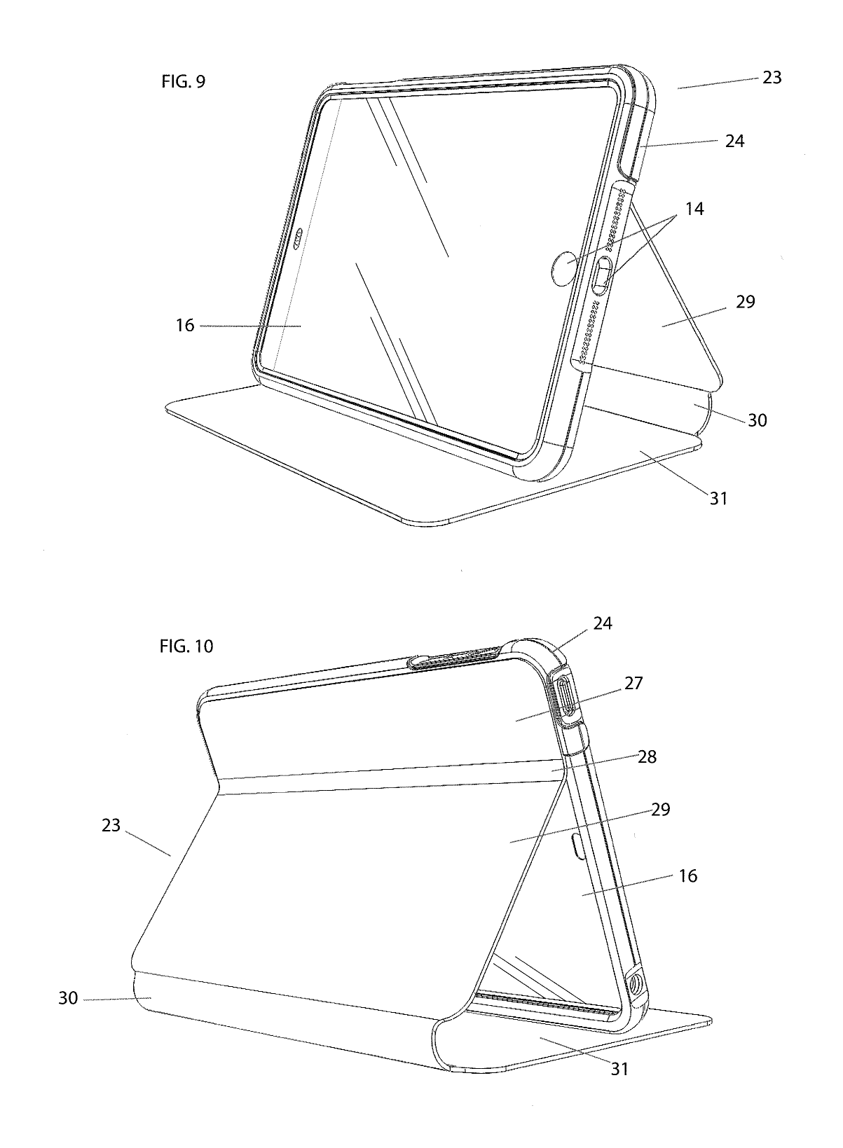

The stand 23 may be manufactured out of a variety of materials. For example, the stand may have a core that is made of cardboard or a plastic polymer (e.g., polycarbonate or acrylonitrile butadiene styrene (ABS)) that is surrounded with a fabric. The fabric may be adhered to the core material by stitching, glue, or the like. The core material may be rigid and may be used to form one or more back portions of the stand 23. The stand portions may have a thickness of 0.75 mm to 3 mm. One or more portions of the stand 23 may have anti-slip portions that have a coefficient of friction that is sufficient to prevent the electronic device from slipping. For example, the stand 23 may made of a roughened surface (e.g., dented, embossed, sand-paper like), or by another type of surface that improves friction resistance. The first back portion 27, as shown in FIGS. 8-9, can extend over at least 25%, and less than 50%, of the width of the back side of the electronic device 1. In an implementation, the first back portion 27 can extend over at least 25%, and less than 35%, of the width of the back side of the electronic device 1. Within these ranges, the stand 23 has the capability to support the weight of the electronic device 1 at a large range of viewing angles.

The stand 23 may include one or more flexible regions that act as hinges 28, 30, and that are coupled to one or more portions that are less flexible (e.g., back portions 27, 29, 31). A hinge may allow one or more back portions to pivot about the hinge. The hinge may be made of a flexible material such as a flexible plastic or fabric. A hinge may be more flexible than the back portion of the stand 23.

FIG. 9 shows the stand 23 attached to the screen and perimeter protector 15 from a front perspective. FIG. 10 shows the stand 23 attached to the screen and perimeter protector 15 from a rear perspective. The stand may include a first back portion 27 that extends over a portion of the back side of the device and that is connected to the perimeter portion 24 as a single continuous piece. The first back portion 27 may reduce the percentage of the back side of the electronic device that is exposed to the atmosphere by at least 10%. The first back portion 27 may be parallel to the back side of the electronic device.

A first hinge region 28 may connect the first back portion 27 to a second back portion 29. A hinge region may be made of a flexible material such as those provided above. A hinge region may allow the second back portion 29 to be articulated or pivoted about the hinge such that the angle formed between the first back portion 27 and the second back portion 29 may range from 0 to 180 degrees. As a matter of practical usage, a user generally may pivot or articulate the second back portion 29 away from the back side of the electronic device. Thus, the first back portion 27 does not move independent of the position of the electronic device; it is stationary and secured to the electronic device. The second back portion, however, may be articulated away from the back side of the electronic device if a user desires to position the electronic device on a planar surface. The stand 23 may include a second hinge 30 region that connects the second back portion 29 to a third back portion 31.

A user may position the electronic device in an upright position on a table, where the electronic device is supported by the stand. The stand may be capable of supporting the weight of the electronic device in the upright position. In some instances, the second back portion may be flush against the back side of the electronic device with the first back portion. Thus, the second back portion may have a variety of positions. In a first position (see, e.g., FIGS. 10-13), it may be planar with the first back portion. In a second position (see, e.g., FIGS. 8-9), the second back portion may extend away from the back side of the electronic device. Similarly, the third back portion may, in the first position, be parallel to the display of the device, or articulated away from the display of the device by 180 degrees. In some cases, the second hinge may allow the third back portion to be articulated nearly 360 degrees. The third back portion 31 may extend underneath a side of the electronic device when the second back portion 29 is in the second position described above. Thus, the third back portion may be parallel to the surface on which the electronic device is being positioned in some instances.

In the second position, such as when the electronic device is positioned in an upright position while disposed in the stand, the weight of the electronic device may rest on an interior part of the third back portion. FIGS. 9 and 10 provide examples of the screen and perimeter protector disposed in the stand and resting on the third back portion. The third back portion may have anti-slip materials on the interior surface or portions of the interior surface that provide a higher coefficient of friction to increase grip, thereby preventing the device and/or screen and perimeter protector from slipping when the stand is positioned as shown in FIGS. 9 and 10.

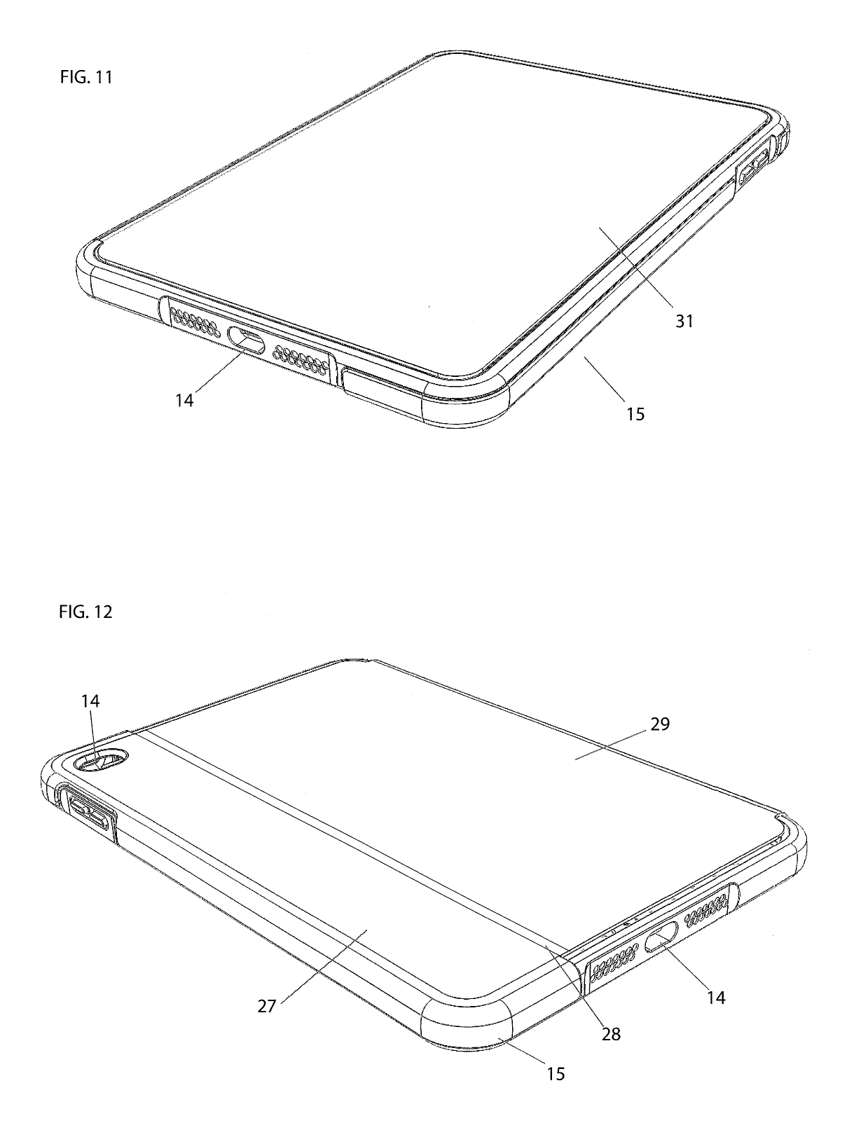

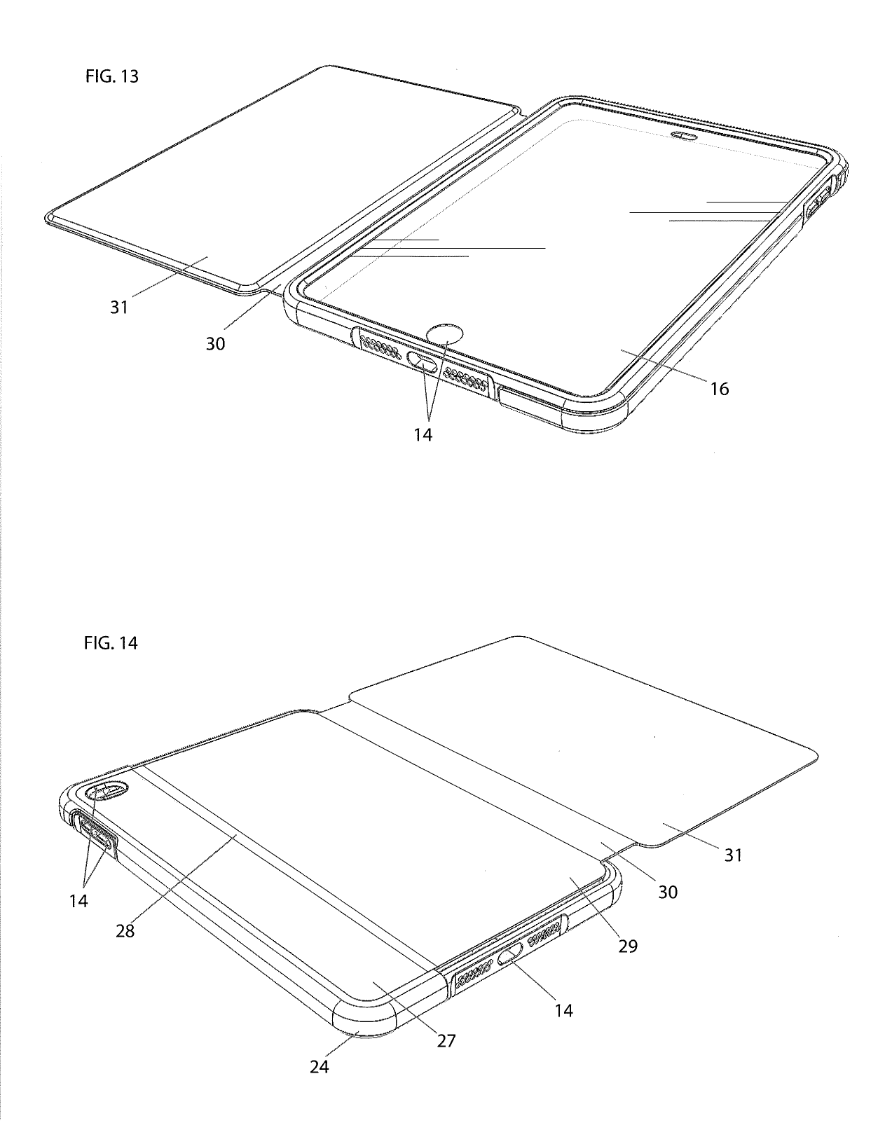

FIG. 11 shows the screen and perimeter protector 15 with the third back portion 31 folded over the front side of the screen and perimeter protector 15. That is, the third back portion 31 may extend over the display 3 of the electronic device 1. FIG. 12 shows the back side of the stand 23 where the second back portion 29 is in the first position, and the third back portion 31 is folded over the front side of the screen and perimeter protector 15. In FIG. 13, the third back portion can be flush with the first back portion and the second back portion. FIG. 14 illustrates a back perspective of the stand 23 when the third back portion 31 is planar with the first back portion 27 and the second back portion 29. When the third back portion is disposed such that it covers the display of the electronic device, it can provide an added layer of protection to the electronic device's front side.

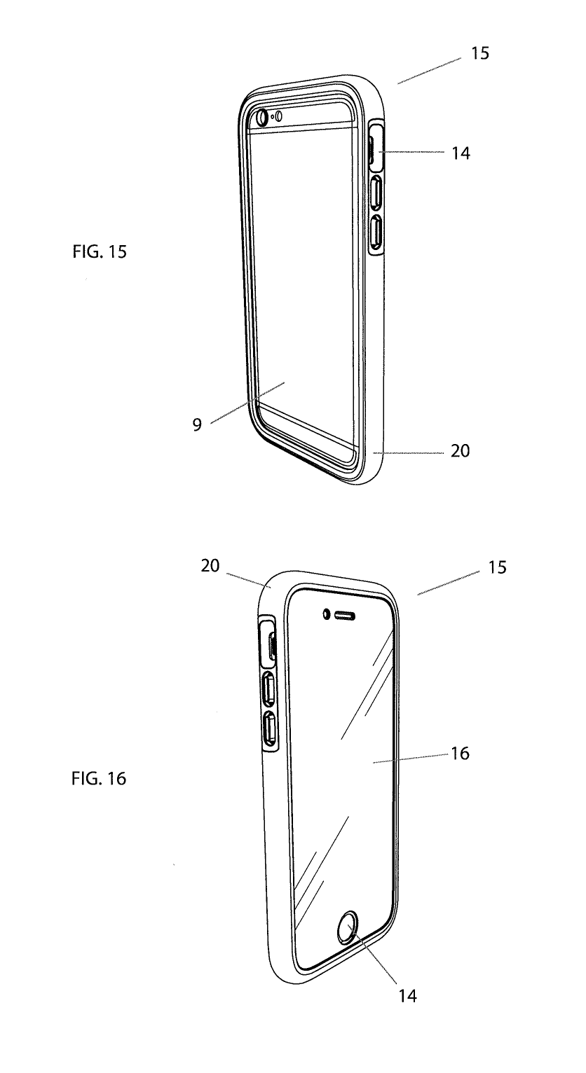

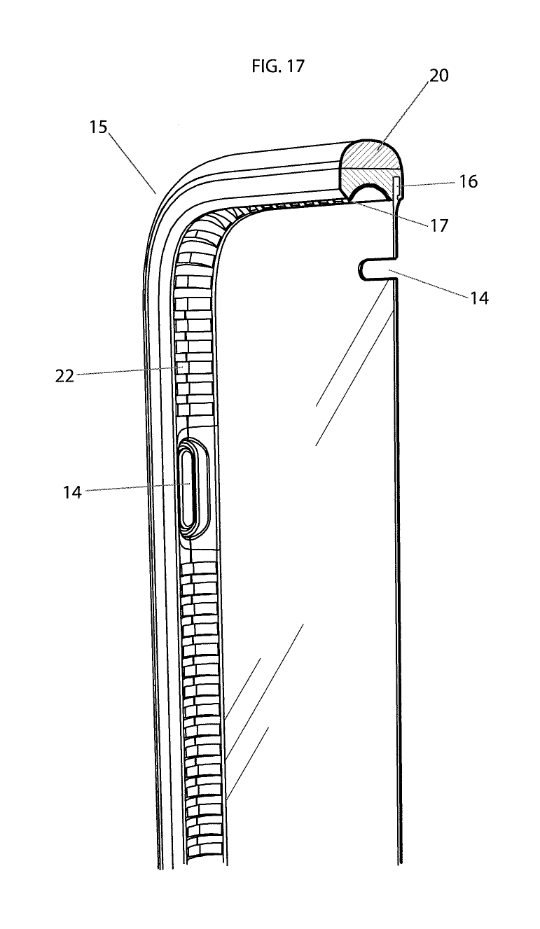

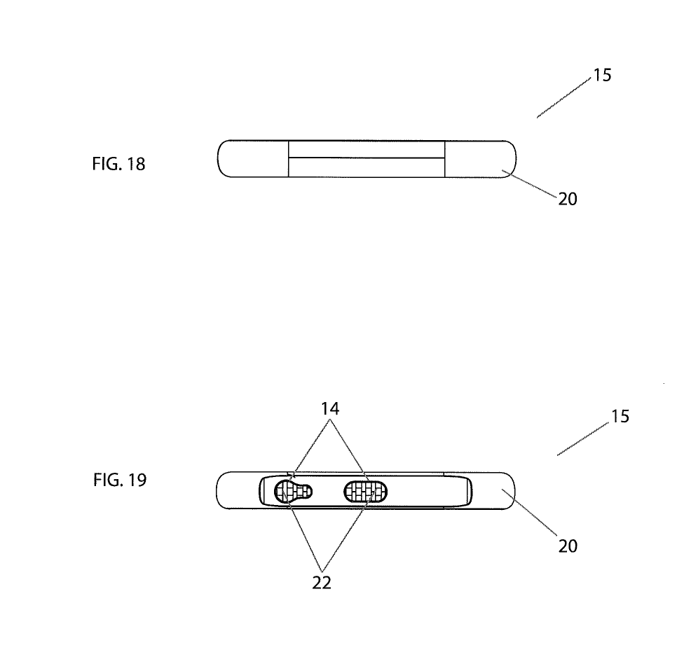

In an implementation, which is illustrated in FIGS. 1-2 and 15-25, a screen and perimeter protector 15 for an electronic device 1 is provided that includes a screen protection layer 16, and an outer layer 20. The screen protection layer in this implementation may extend over a portion of the front side of the electronic device 1. FIG. 1 shows an electronic device 1 and the screen and perimeter protector 15 from a back perspective. FIG. 2 shows the electronic device 1 and the screen and perimeter protector 15 from a front perspective. The screen protection layer 16 in the implementation illustrated in FIGS. 1-2 and 15-25 does not extend to the back side 9 of the electronic device 1. It may, in some instances, extend over a portion of the perimeter of the device 1. The screen protection layer 16 and the outer layer 20 are bonded together, such that they form a single piece. As described earlier, the screen protection layer 16 and/or the outer layer 20 may have one or more openings 14. FIG. 15 shows the electronic device 1 disposed in the screen and perimeter protector 15 from a back perspective (e.g., the back side 9 of the electronic device is exposed to the atmosphere). FIG. 16 shows the electronic device 1 disposed in the screen and perimeter protector 15 from a front perspective (e.g., the display of the electronic device is visible through the screen protector layer). FIG. 17 shows a cross-section view of screen and perimeter protector 15 from a back perspective, including the outer layer 20, screen protector layer 16, and an internal liner 22. As illustrated in FIG. 16, the screen protector layer 16 may not extend over the perimeter and/or the back side 9 of the electronic device 1 when the device 1 is disposed in the screen and perimeter protector 15, according to an implementation FIG. 18 shows a top side of the screen and perimeter protector 15. FIG. 19 shows a bottom side of the screen and perimeter protector 15.

The outer layer in this implementation may extend over a portion of the back side 9 of the electronic device 1 such that the electronic device 1 is secured in the screen and perimeter protector 15 by the outer layer 20. The screen and perimeter protector 15 may grip or be securely attached to an electronic device 1 by a portion of the outer layer 20 that extends over a portion of the back side of the electronic device 1. The screen and perimeter protector 15 may be designed to have an opening on the back side that is slightly smaller than the dimensions of the electronic device 1. As a device 1 is installed, display first, into the back side of the screen and perimeter protector 15, the material forming the screen and perimeter protector, such as the outer layer 20, can flex and snap around the perimeter of the electronic device 1. The portion of the outer layer that extends over the back side of the device is relatively small (e.g., it may be a lip 17), as illustrated in FIG. 17. For example, the outer layer may extend around the back side of the device, as measured from an edge of the back side of the device to the edge of where the outer layer ends on the back side of the device, at a length of less than 5 mm, than 4 mm, less than 3 mm, less than 2 mm, less than 1.0 mm, and less than 0.5 mm. Thus, at least 75% of the back side of the electronic device is exposed to the atmosphere when the electronic device is disposed in the screen and perimeter protector. In some configurations, at least 90%, at least 95%, at least 98% or at least 99% of the back side of the electronic device is exposed to atmosphere (e.g., a user can directly interface with over 98% of the electronic device).

The screen and perimeter protector 15 fits relatively snug against the electronic device 1, based on the offset of the outer layer and geometry (e.g., shape and/or size) of the screen and perimeter protector in relation to a particular electronic device. The offset from the electronic device may be 0.3 mm or less, 0.1 mm or less, or directly contacting the electronic device. Thus, no adhesive is required to secure the electronic device 1 to any part of the screen and perimeter protector 15. The device is held securely by the outer layer (e.g., does not move in the screen and perimeter protector 15, or fall out of the screen and perimeter protector). Similarly, it is easier, as compared to a conventional case or screen protector, to install an electronic device in the screen and perimeter protector (or uninstall it) because it snaps around the device. The geometry of the screen and perimeter protector 15 also maintains a thin shape in relation to the electronic device 1.

In some configurations, the outer layer 20 may encompass only the corners of the electronic device. That is, when an electronic device 1 is disposed in the screen and perimeter protector with such a configuration, only the corner portions of the perimeter are protected (e.g., not exposed to atmosphere). The screen and perimeter protector 15 may have a geometry to accommodate devices with greater than four sides as well. In some configurations, the outer layer 20 may not extend over the corners of the electronic device. That is, the corners may be unprotected while the other portions of the perimeter (e.g., sides of the electronic device) may be protected.

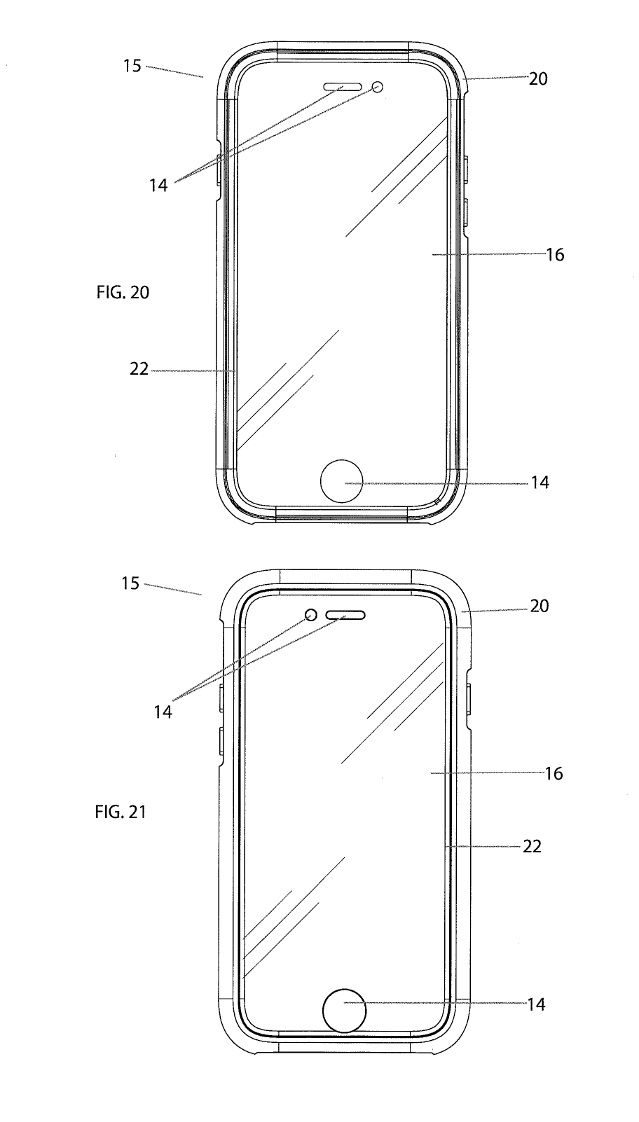

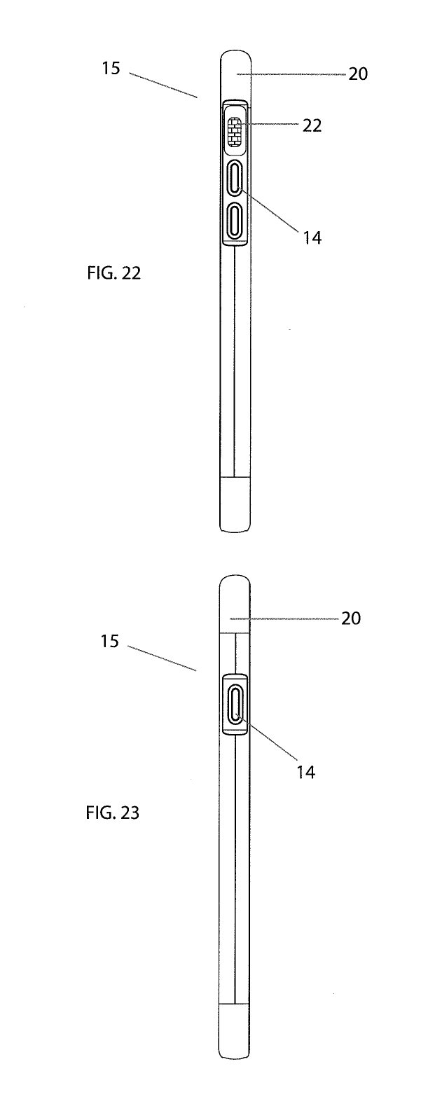

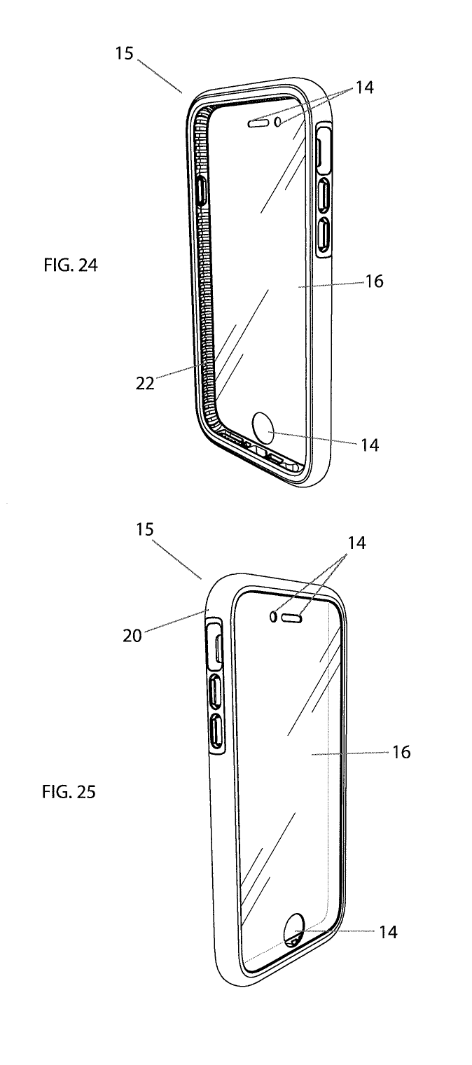

In some configurations, an internal liner, as described above, may be disposed between the outer layer 20 and the electronic device 1. Thus, rather than the outer layer 20 contacting the perimeter of the electronic device 1, the internal line contacts or is offset by less than 0.3 mm, or less than 0.1 mm from the electronic device 1. FIG. 20 shows a screen and perimeter protector 15 that includes a screen protector layer 16, an outer layer 20, and an inner liner 22 from a back side. FIG. 21 shows a screen and perimeter protector 15 that includes a screen protector layer 16, an outer layer 20, and an inner liner 22 from a front side. FIG. 22 shows a screen and perimeter protector 15 that includes a screen protector layer 16, an outer layer 20, and an inner liner 22 from a left side. FIG. 23 shows a screen and perimeter protector 15 that includes a screen protector layer 16, an outer layer 20, and an inner liner 22 from a right side. FIG. 24 shows a screen and perimeter protector 15 that includes a screen protector layer 16, an outer layer 20, and an inner liner 22 from a back perspective. FIG. 25 shows a screen and perimeter protector 15 that includes a screen protector layer 16, an outer layer 20, and an inner liner 22 from a front perspective.

In an implementation, a system is provided that includes the screen and perimeter protector and a stand. The screen and perimeter protector includes an outer layer that extends over the perimeter of the electronic device and that is bonded to a screen protector layer. The outer perimeter secures the screen and perimeter protector to the electronic device as described above.

The stand is substantially described above and illustrated in FIGS. 6-14. In the instant implementation, the perimeter portion may extend over the portion of the outer layer that extends over the perimeter of the electronic device. The perimeter portion may also extend over a portion of the front side of the electronic device, without obstructing the electronic device's display.

The above implementations can accommodate a variety of device types. FIGS. 26-36 show different views of a smartwatch implementation. These figures also illustrate an example of a curved screen and/or chassis implementation. A curved screen and/or chassis may be found in a variety of devices, including a table or smartphone. The stand and screen and perimeter protector as disclosed herein can be designed to accommodate such curved screen and/or chassis designs. Thus, the screen and perimeter protector may be designed to fit other devices of different shapes and sizes than those specifically illustrated herein.

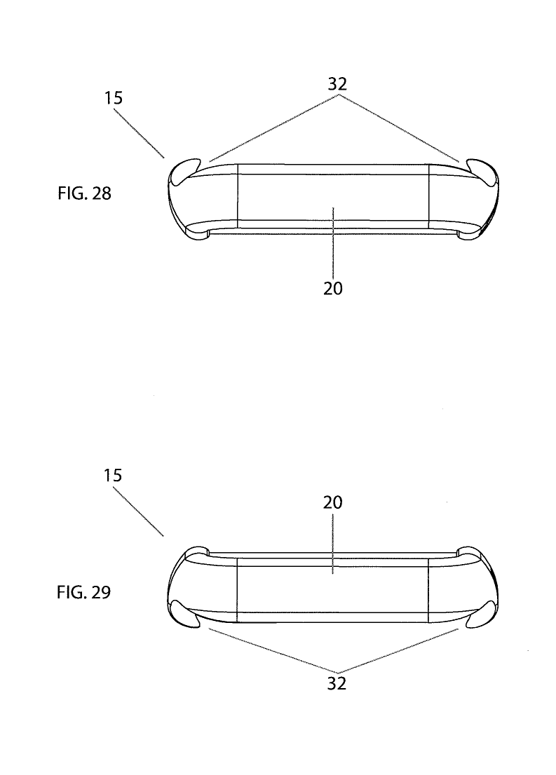

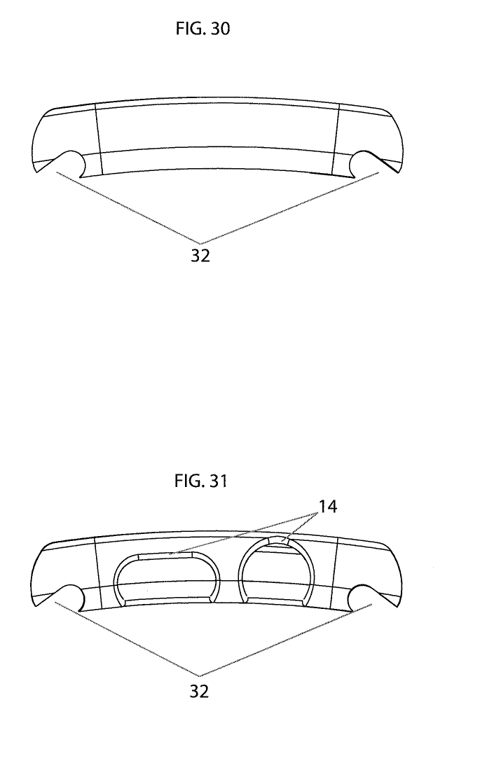

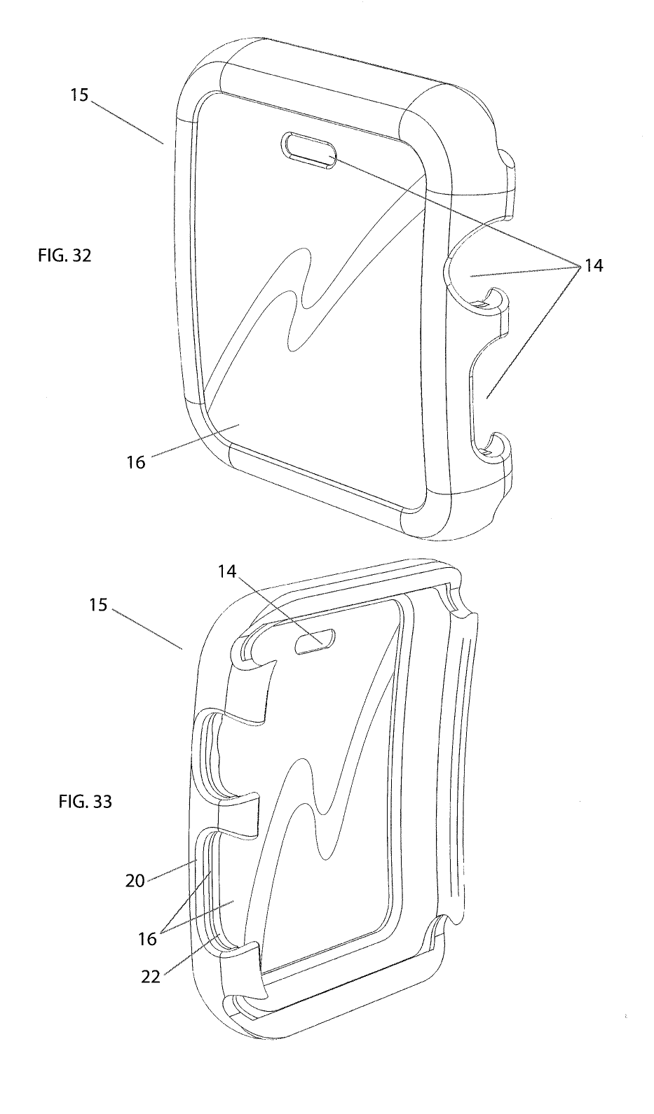

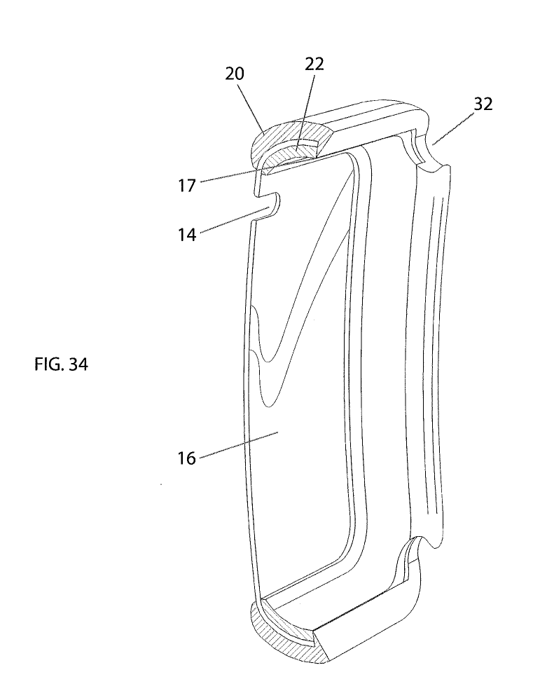

FIG. 26 shows a screen and perimeter protector 15 for a smartwatch that includes a screen protector layer 16, an outer layer 20, and an inner liner 22 from a front side. FIG. 27 shows a screen and perimeter protector 15 for a smartwatch that includes a screen protector layer 16, an outer layer 20, and an inner liner 22 from a back side. A smartwatch may have one or more openings 14 for a dial, sensor, emissive component, and input keys (e.g., a slidable switch or button). FIG. 28 shows a screen and perimeter protector 15 for a smartwatch that includes a screen protector layer 16, an outer layer 20, and an inner liner 22 from a top side. The smartwatch may have notches 32 for the attachment of a wristband. FIG. 29 shows a screen and perimeter protector 15 for a smartwatch that includes a screen protector layer 16, an outer layer 20, and an inner liner 22 from a bottom side. FIG. 30 shows a screen and perimeter protector 15 for a smartwatch that includes a screen protector layer 16, an outer layer 20, and an inner liner 22 from a left side. FIG. 31 shows a screen and perimeter protector 15 for a smartwatch that includes a screen protector layer 16, an outer layer 20, and an inner liner 22 from a right side. FIG. 32 shows a screen and perimeter protector 15 for a smartwatch that includes a screen protector layer 16, an outer layer 20, and an inner liner 22 from a front perspective. FIG. 33 shows a screen and perimeter protector 15 for a smartwatch that includes a screen protector layer 16, an outer layer 20, and an inner liner 22 from a back perspective.

FIG. 34 shows a cross section of the screen and perimeter protector 15 for a smartwatch that includes a screen protector layer 16, an outer layer 20, and an inner liner 22. As described above, the outer layer 20 may have a portion that forms a lip 17 that extends over a portion of the electronic device 1 when it is disposed in the case. This feature allows the electronic device 1 to be securely held in the screen and perimeter protector.

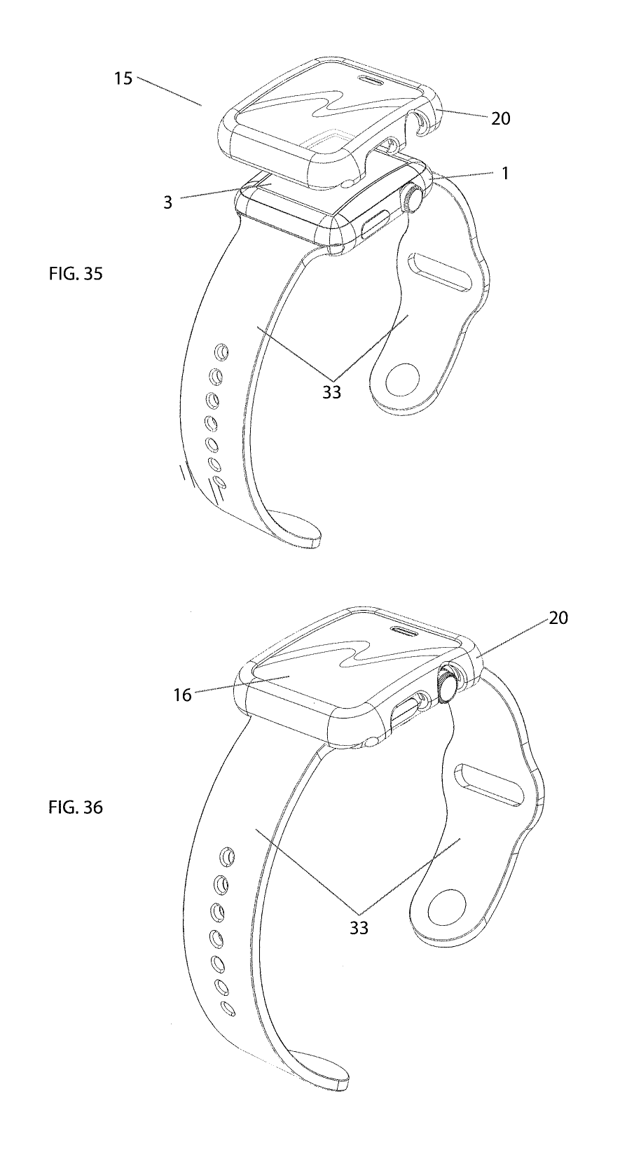

FIG. 35 shows an electronic device 1 and screen and perimeter protector 15 for a smartwatch that includes a screen protector layer 16, an outer layer 20, and an inner liner 22 from a back side. The wristband 33 may be secured to the electronic device (i.e., the smartwatch) by a variety of methods, including the use of the notches 32 on the smartwatch chassis. FIG. 36 shows an electronic device disposed in the screen and perimeter protector 15 for a smartwatch that includes a screen protector layer 16, an outer layer 20, and an inner liner 22 from a front perspective.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, thereby enabling others skilled in the art to utilize those embodiments as well as various embodiments with various modifications as may be suited to the particular use contemplated.

1. A screen and perimeter protector for an electronic device, comprising:
a screen protection layer comprised of a transparent material that extends over at least a portion of a front side of the electronic device containing a display, and at least a portion of a perimeter of the device, wherein the transparent material is not adhered to any component of the electronic device;
wherein the transparent material extends over at least a portion of a back side of the electronic device, such that the electronic device is secured in the screen and perimeter protector, and
wherein greater than 75% of the back side of the electronic device is exposed to atmosphere when the electronic device is disposed in the screen and perimeter protector.

2. The screen and perimeter protector of claim 1, wherein the portion of the back side of the electronic device that is extended over by the screen protection layer is selected from the group consisting of: less than 5 mm, less than 4 mm, less than 3 mm, less than 2 mm, less than 1.0 mm, and less than 0.5 mm.

3. The screen and perimeter protector of claim 1, wherein the electronic device has a curved screen and a shape of the screen protection layer matches the curved screen.

4. The screen and perimeter protector of claim 1, wherein the screen protection layer has an opening for at least one or more sensors, emissive components, cable inputs, and input keys of the electronic device.

5. The screen and perimeter protector of claim 1, wherein the screen protection layer has a thickness that is selected from the group consisting of: less than 1.0 mm thick, less than 0.8 mm thick, less than 0.6 mm thick, less than 0.5 mm thick, less than 0.4 mm thick.

6. The screen and perimeter protector of claim 1, wherein the screen protection layer extends over the entire perimeter of the electronic device except where the electronic device has a sensor, an emissive component, a cable input, or an input key of the electronic device.

7. The screen and perimeter protector of claim 1, wherein greater than 90% of the back side of the electronic device is exposed to the atmosphere.

8. The screen and perimeter protector of claim 1, further comprising an outer layer that extends over the portion of the transparent material that extends over the at least the portion of the perimeter of the electronic device, wherein the screen protection layer and the outer layer are bonded together.

9. The screen and perimeter protector of claim 8, wherein the outer layer is a material selected from the group consisting of: liquid silicone rubber, polyurethane, polyethylene, silicone, gel, and rubber.

10. The screen and perimeter protector of claim 8, further comprising an internal liner that is disposed between the portion of the transparent material that extends over the at least the portion of the perimeter of the electronic device, and the electronic device when the electronic device is disposed in the screen and perimeter protector.

11. The screen and perimeter protector of claim 10, wherein the internal liner is a material selected from the group consisting of: liquid silicone rubber, polyurethane, polyethylene, silicone, gel, and rubber.

12. The screen and perimeter protector of claim 10, wherein the internal liner has a shape selected from the group consisting of a spring and a ribbed shape.

13. The screen and perimeter protector of claim 1, further comprising an internal liner that is disposed between the portion of the transparent material that extends over the at least the portion of the perimeter of the electronic device, and the electronic device when the electronic device is disposed in the screen and perimeter protector.

14. The screen and perimeter protector of claim 13, wherein the internal liner has a shape selected from the group consisting of a spring and a ribbed shape.

15. A system for protecting an electronic device, comprising:
a screen and perimeter protector for an electronic device, comprising:
a screen protection layer comprised of a transparent material that extends over at least a portion of a front side of the electronic device containing a display, and at least a portion of a perimeter of the device, wherein the transparent material is not adhered to any component of the electronic device;
wherein the transparent material extends over at least a portion of a back side of the electronic device, such that the electronic device is secured in the screen and perimeter protector, and
wherein greater than 75% of the back side of the electronic device is exposed to atmosphere when the electronic device is disposed in the screen and perimeter protector, and
a stand, wherein the stand comprises:
a perimeter portion that extends over a portion of the screen protection layer that extends over a portion of the front side and the perimeter of the electronic device;
a first back portion that extends over a portion of the back side of the electronic device when the electronic device is disposed in the screen and perimeter protector; and
a first hinge region that connects the first back portion to a second back portion;
a second hinge region that connects the second back portion to a third back portion;
wherein the second back portion, in a first position, is planar to the first back portion, and in a second position, extends outward from the first back portion of the stand and is capable of supporting the weight of the electronic device, and
wherein the third back portion, in the first position, is parallel to the first back portion and the second back portion, and in the second position, is parallel to a surface on which the electronic device is positioned while the electronic device is disposed in the screen and perimeter protector and the screen and perimeter protector is attached to the stand.

16. A screen and perimeter protector for an electronic device, comprising:
a screen protection layer comprising a transparent material, and that extends over at least a portion of a front side of the electronic device containing a display, wherein the transparent material is not adhered to any component of the electronic device;
an outer layer that extends over at least a portion of a perimeter of the electronic device, wherein the screen protection layer and the outer layer are bonded together;
wherein at least a portion of the outer layer extends over a portion of a back side of the electronic device, such that the electronic device is secured in the screen and perimeter protector by the outer layer; and
wherein greater than 75% of the back side of the electronic device is exposed to atmosphere when the electronic device is disposed in the screen and perimeter protector.

17. The screen and perimeter protector of claim 16, wherein the portion of the back side of the electronic device that is extended over by the outer layer is selected from the group consisting of: less than 5 mm, less than 4 mm, less than 3 mm, less than 2 mm, less than 1.0 mm, and less than 0.5 mm.

18. The screen and perimeter protector of claim 16, wherein the electronic device has a curved screen and a shape of the screen protection layer matches the curved screen.

19. The screen and perimeter protector of claim 18, wherein the electronic device has a curved screen and a shape of the outer layer matches a curved perimeter of the curved screen.

20. The screen and perimeter protector of claim 16, wherein the screen protection layer has an opening for at least one or more sensors, emissive components, cable inputs, and input keys of the electronic device.

21. The screen and perimeter protector of claim 16, wherein the outer layer has an opening for at least one or more sensors, emissive components, cable inputs, and input keys of the electronic device.

22. The screen and perimeter protector of claim 16, wherein the screen protection layer has a thickness that is selected from the group consisting of: less than 1.0 mm thick, less than 0.8 mm thick, less than 0.6 mm thick, less than 0.5 mm thick, less than 0.4 mm thick.

23. The screen and perimeter protector of claim 16, wherein the outer layer has a thickness that is selected from the group consisting of: less than 8 mm thick, less than 7 mm thick, less than 6 mm thick, less than 5 mm thick, less than 3 mm thick.

24. The screen and perimeter protector of claim 16, wherein the outer layer extends over the entire perimeter of the electronic device except where the electronic device has a sensor, an emissive component, a cable input, or an input key of the electronic device.

25. The screen and perimeter protector of claim 16, wherein greater than 90% of the back side of the electronic device is exposed to the atmosphere.

26. The screen and perimeter protector of claim 16, further comprising an internal liner that is disposed between the outer layer and the electronic device when the electronic device is disposed in the screen and perimeter protector.

27. The screen and perimeter protector of claim 27, wherein the internal liner has a shape selected from the group consisting of a spring and a ribbed shape.

28. A system for protecting an electronic device, comprising:
a screen and perimeter protector for an electronic device, comprising:
a screen protection layer comprising a transparent material that extends over at least a portion of a front side of the electronic device containing a display, wherein the transparent material is not adhered to any component of the electronic device;
an outer layer that extends over at least a portion of a perimeter of the electronic device, wherein the screen protection layer and the outer layer are bonded together;
wherein at least a portion of the outer layer extends over a portion of a back side of the electronic device, such that the electronic device is secured in the screen and perimeter protector by the outer layer; and
wherein greater than 75% of the back side of the electronic device is exposed to atmosphere when the electronic device is disposed in the screen and perimeter protector;
a stand, wherein the stand comprises:
a perimeter portion that extends over at least a portion of the outer layer that extends of a portion of the front side and the perimeter of the electronic device;
a first back portion that extends over a portion of the back side of the electronic device when the electronic device is disposed in the screen and perimeter protector; and
a first hinge region that connects the first back portion to a second back portion;
a second hinge region that connects the second back portion to a third back portion;
wherein the second back portion, in a first position, is planar to the first back portion, and in a second position, extends outward from the first back portion of the stand and is capable of supporting the weight of the electronic device, and
wherein the third back portion, in the first position, is parallel to the first back portion and the second back portion, and in the second position, is parallel to a surface on which the electronic device is positioned while the electronic device is disposed in the screen and perimeter protector and the screen and perimeter protector is attached to the stand.
